(19) United States
(12) Patent Application Publication
(10) Pub. No.: US 2023/0001739 A1
(43) Pub. Date: Jan. 5, 2023

(54) MOBILE BODY

(71) Applicant: TOYOTA JIDOSHA KABUSHIKI KAISHA, Toyota-shi (JP)

(72) Inventors: Kazuhiro TOYAMA, Toyota-shi (JP); Osamu NISHIMURA, Chiryuu-shi (JP); Shinobu ISHIDA, Toyota-shi (JP)

(73) Assignee: TOYOTA JIDOSHA KABUSHIKI KAISHA, Toyota-shi (JP)

(21) Appl. No.: 17/807,517

(22) Filed: Jun. 17, 2022

(30) Foreign Application Priority Data
Jul. 2, 2021 (JP) 2021-110581

(51) Int. Cl. B60B 19/00; B60B 19/12

(52) U.S. Cl. CPC B60B 19/003; B60B 19/12; B60B 2360/50; B60B 2360/324

(57) ABSTRACT

A mobile body according to the disclosure has an omni wheel in which a pair of wheels is arranged parallel to each other so that phases of the wheels are shifted from each other. Each of the wheels having a plurality of rollers in a circumferential direction. The rigidity of a center portion of each of the rollers in an axis direction is higher than rigidity of an end portion of the roller in the axis direction.

### CROSS-REFERENCE TO RELATED APPLICATION

This application claims priority to Japanese Patent Application No. 2021-110581 filed on Jul. 2, 2021, incorporated herein by reference in its entirety.

### BACKGROUND

### 1. Technical Field

The disclosure relates to a mobile body, especially to a mobile body having an omni wheel.

### 2. Description of Related Art

An omni wheel is a tire-wheel assembly in which wheels each having a plurality of rollers are arranged in parallel to each other so that phases of the wheels are shifted with respect with each other. The omni wheel is used as a caster for a mobile body such as a robot, a container, and a cart. The mobile body having the omni wheel is able to turn on the spot and move in all directions.

As a usage example of an omni wheel, Japanese Unexamined Patent Application Publication No. 2017-149262 (JP 2017-149262 A) discloses a technology related to an omni wheel assembly in which a ratio of contact of a barrel (a roller) with a road surface is increased compared to that of an omni wheel even during a travel on a curved road surface where curvature changes on the way.

### SUMMARY

Wheels included in an omni wheel are structured so that their phases are shifted with respect to each other. Therefore, when a mobile body having the omni wheel travels, there is timing when only one of the wheels is grounded. At this time, since a load is applied only to the one of the wheels, an axle sinks more compared to when both of the wheels are grounded. Thus, there was a problem that the mobile body vibrates while it is traveling. With the method described in JP 2017-149262 A, grounding of a roller of one of the wheels and, and grounding of rollers of both of the wheels are repeated while a mobile body is traveling. Therefore, vibration of the mobile body still happens.

The disclosure has been accomplished in order to solve this problem, and an object thereof is to provide a mobile body in which vibration is reduced while the mobile body is traveling.

A mobile body according to an aspect of the disclosure is a mobile body having an omni wheel in which a pair of wheels is arranged parallel to each other so that phases of the wheels are shifted from each other. Each of the wheels has a plurality of rollers in a circumferential direction. Rigidity of a center portion of each of the rollers in an axis direction is higher than rigidity of an end portion of the roller in the axis direction.

While the mobile body having the omni wheel is traveling, when the rollers of both of the wheels receive a load, the load is dispersed because the end portions of the two rollers receive the load. On the other hand, when only the roller of one of the wheels receives the load, the center portion of the single roller receives the load, and sinking of the axle is larger than that when the rollers of both of the wheels receive the load. In the mobile body according to the aspect of the disclosure, rigidity of the center portion of the roller in the axis direction is higher than the rigidity of the end portion of the roller in the axis direction. Therefore, when only the roller of one of the wheels receives the load, sinking of the axle is reduced. This means that, with the mobile body according to the aspect of the disclosure, it is possible to bring an amount of sinking of the axis when only the roller of one of the wheels receives the load, and an amount of sinking of the axis when the rollers of both of the wheels receive the load to a uniform value. As a result, it is possible to reduce vibration of the mobile body while it is traveling.

According to the disclosure, it is possible to provide a mobile body in which vibration is reduced while the mobile body is traveling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a mobile body according to a first embodiment;

FIG. 2 is a perspective view of an omni wheel according to the first embodiment;

FIG. 3 is a front view of the omni wheel according to the first embodiment;

FIG. 4 is a front view of the omni wheel according to the first embodiment;

FIG. 5 is a sectional view of a roller according to the first embodiment;

FIG. 6 is a view of a state where a roller of one of wheels of an omni wheel according to a comparative example is grounded;

FIG. 7 is a view of a state where rollers of both of the wheels of the omni wheel according to the comparative example are grounded;

FIG. 8 is a view illustrating a grounded portion of the roller of one of the wheels of the omni wheel according to the comparative example;

FIG. 9 is a view illustrating grounded portions of the rollers of both of the wheels of the omni wheel according to the comparative example;

FIG. 10 is a graph illustrating vertical vibration of an axis of the omni wheel according to the comparative example; and

FIG. 11 is a graph illustrating vertical vibration of an axis of the omni wheel according to the first embodiment.

### DETAILED DESCRIPTION OF EMBODIMENTS

Hereinafter, a specific embodiment to which the disclosure is applied is described in detail with reference to the drawings. However, the disclosure is not limited to the embodiment described below. Also, in order to make the description clear, the following description and drawings are simplified as necessary.

### First Embodiment

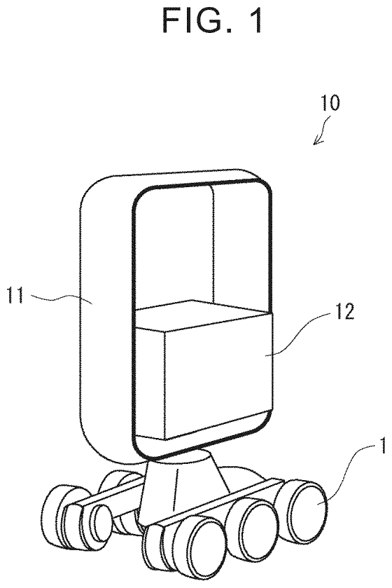

With reference to FIG. 1, a mobile body according to a first embodiment is described. FIG. 1 is a perspective view of the mobile body according to the first embodiment.

As illustrated in FIG. 1, a mobile body 10 has omni wheels 1. The mobile body 10 is able to turn at the point and move in every direction as the omni wheels 1 are driven. For example, the mobile body 10 can be used as mobile means that carries goods and people. For example, as illustrated in FIG. 1, the mobile body 10 may be provided with a frame-shaped body portion 11 usable for storage of goods 12 and so on. Thus, the mobile body 10 is able to transport the goods 12.

Further, in FIG. 1, the mobile body 10 is provided with three pairs of (therefore, totally six) omni wheels 1 so that those in pairs face each other. However, the number of the omni wheels 1 are not limited to this, and may be any number that enables the mobile body 10 usable. The mobile body 10 may be autonomously-acting mobile means, or a mobile means that behaves in accordance with an instruction by an administrator or the like of the mobile body 10.

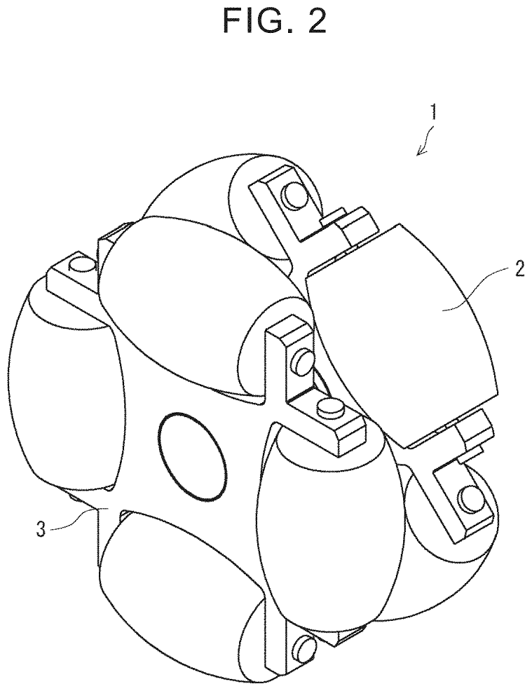

FIG. 2 is a perspective view of the omni wheel 1 according to the first embodiment. In each of the omni wheels 1, a pair of wheels 3 each having a plurality of rollers 2 arranged in a circumferential direction are arranged so that phases of the wheels 3 are shifted from one another. In FIG. 2, each of the wheels 3 has the four rollers 2 at 90 degrees in the circumferential direction. Also, in the omni wheel 1, the wheels 3 are arranged in parallel to each other while the phases thereof are shifted by 45 degrees from each other. Therefore, the roller 2 provided in one of the wheels 3 is positioned between the neighboring rollers 2 of the other wheel 3. The number of the rollers 2 provided in the wheel 3 is not limited to above, and any number of rollers 2 such as three or five may be provided in the wheel 3. Also, it is possible to structure the omni wheel 1 having any number of rollers 2 as the phases of the wheels 3 in a pair is shifted differently in accordance with the number of the rollers 2.

Rotation axes of the four rollers 2 provided in the wheel 3 are perpendicular to a rotation axis of the wheel 3. Therefore, the omni wheel 1 enables movement in a first direction as the wheels 3 roll in the circumferential direction, and movement in a second direction perpendicular to the first direction as the rollers 2 roll. Thus, the mobile body 10 having the omni wheels 1 is able to turn at the spot and move in every direction. As described earlier, as the wheels 3 rotate in the circumferential direction, the number of grounded rollers 2 changes.

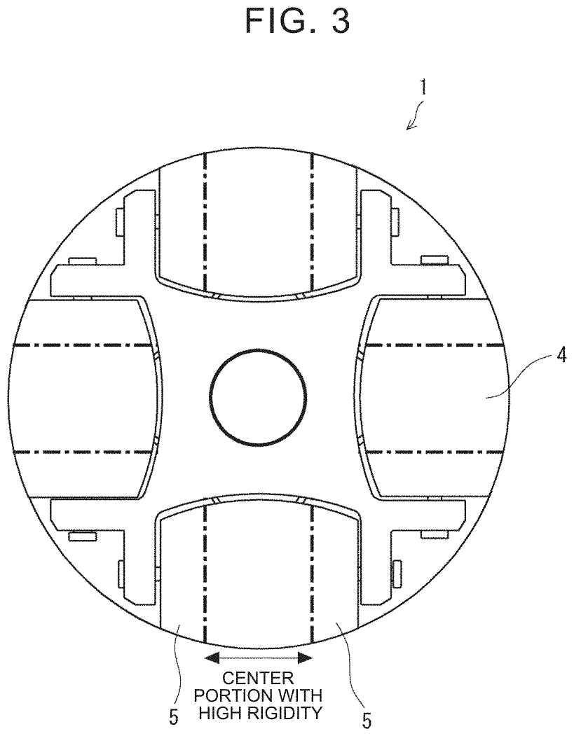

FIG. 3 is a front view of the omni wheel 1 according to the first embodiment. As illustrated in FIG. 3, rigidity of a center portion 4 of each of the rollers 2 in the axis direction of the roller 2 is higher than rigidity of end portions 5 of each of the rollers 2 in the axis direction of the roller 2. Thus, it is possible to bring a sinking amount of an axle when the roller 2 of one of the wheels 3 receives a load, and a sinking amount of the axle when the rollers 2 of both of the wheels 3 receive the load to a uniform value. This means that rigidity of the rollers 2 in the circumferential direction of the wheel 3 is brought closer to a uniform value, and deformation of the rollers 2, in other words, sinking of the wheels 3 are brought closer to a uniform value. Therefore, it is possible to suppress vertical vibration of the mobile body 10. As a result, it is possible to reduce vibration of the mobile body 10 while it is traveling.

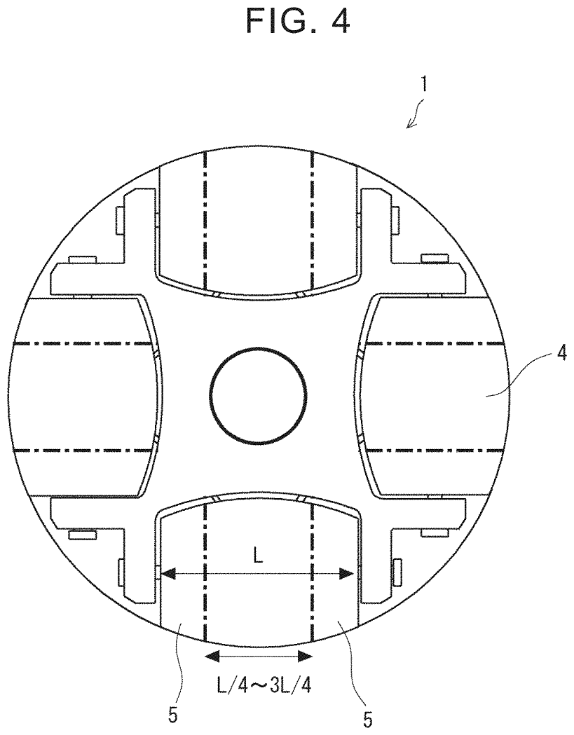

As illustrated in FIG. 4, in order to bring the rigidity of the rollers 2 in the circumferential direction of the wheel 3 to a uniform value, it is further preferred that, when a length of each of the rollers 2 in the axis direction is L, a length of the center portion 4 is in a range of L/4 to 3L/4, and L/2 is even more preferred. Thus, while the wheels 3 are rotating in their circumferential directions, extents of deformation of the rollers 2 are brought closer to a uniform value, and sinking of the wheels 3 is brought closer to a uniform value even further. Therefore, vibration of the mobile body 10 while it is traveling is reduced even further.

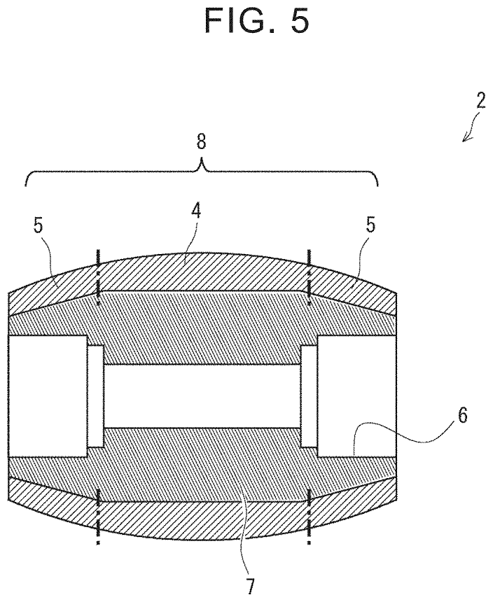

FIG. 5 is a sectional view of the roller 2 according to the first embodiment. The roller 2 according to the first embodiment includes a hole 6, a core 7, and a tire 8. The hole 6 is a hollow portion provided in the core 7, and is used in order to provide a rotating shaft that connects the wheel 3 and the roller 2, and allows the roller 2 to rotate. For the core 7, metal such as aluminum and copper may be used.

The tire 8 is an elastic member covering the core 7. The end portions 5 of the tire 8 are made of a general material, and the center portion 4 of the tire 8 is made of a high-rigidity material having higher rigidity than that of the general material. The high-rigidity material is a material having larger Young's modulus than that of the general material. Thus, it is possible to construct the roller 2 so that the rigidity of the center portion 4 is higher than the rigidity of the end portions 5. From a viewpoint of reduction of vibration of the mobile body 10, it is preferred that the rigidity of the center portion 4 is 1.5 to 2.5 times as high as rigidity of the end portions 5, and rigidity twice as high as that of the end portions 5 is even more preferred.

The center portion 4 and the end portions 5 of the tire 8 contain urethane or a rubber material. For example, it is preferred that urethane or a rubber material at around 90 MPa is used for the general material that constructs the end portions 5, and it is preferred that urethane or a rubber material at around 180 MPa is used for the high-rigidity material that constructs the center portion 4.

Hereinafter, an extent of vibration of a mobile body having omni wheels according to a comparative example while it is traveling, and an extent of vibration of the mobile body 10 having the omni wheels 1 according to the embodiment while it is traveling, are compared. First of all, a mechanism of vibration generated in the omni wheel according to the comparative example is described.

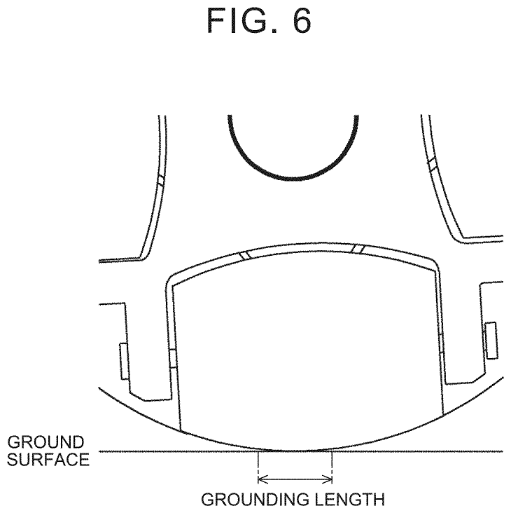

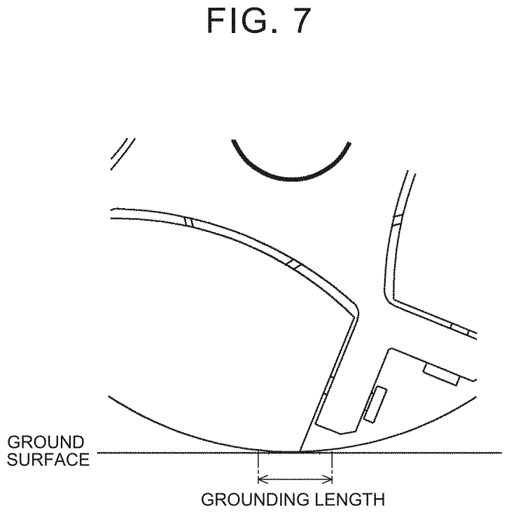

FIG. 6 is a view of a state where a roller of one of wheels of the omni wheel according to the comparative example is grounded. At this time, only one roller is grounded. FIG. 7 is a view of a state where rollers of both wheels of the omni wheel according to the comparative example are grounded. At this time, two rollers are grounded. Here, a grounding length corresponds to a depth of sinking at the time of grounding. This means that, the larger the grounding length is, the deeper the sinking is.

The ground length of the roller of one of the wheels illustrated in FIG. 6 is larger than the grounding length of the rollers of both wheels illustrated in FIG. 7. This means that, when the roller of one of the wheels is grounded, sinking is deeper than that when the rollers of both wheels are grounded.

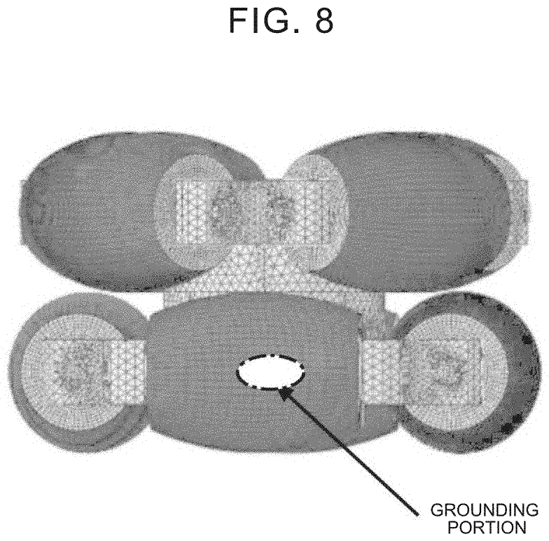

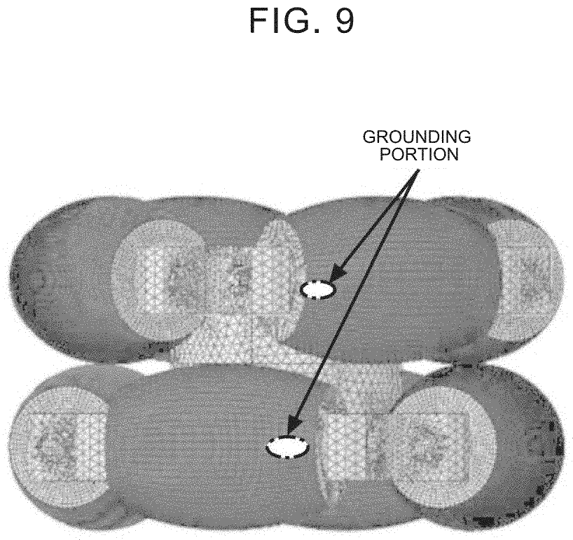

Further, FIG. 8 is a view illustrating a grounded portion of the roller of one of the wheels of the omni wheel according to the comparative example. At this time, only one roller is grounded. FIG. 9 is a view illustrating grounded portions of the rollers of both of the wheels of the omni wheel according to the comparative example. At this time, two rollers are grounded. Here, a size of an area of a grounded portion corresponds to a depth of sinking at the time of grounding. This means that, the larger the area of the grounded portion is, the deeper the sinking is.

The grounded portion of the roller of one of the wheels illustrated in FIG. 8 is larger than the area of the grounded portion of the rollers of both of the wheels illustrated in FIG. 9. This means that, when the roller of one of the wheels is grounded, sinking is deeper than that when the rollers of both of the wheels are grounded.

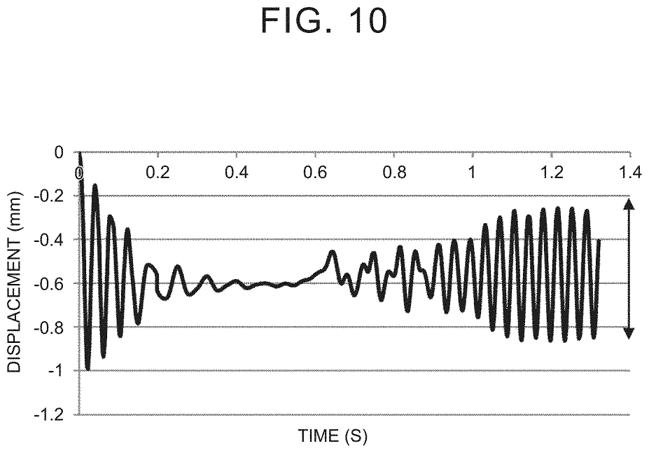

FIG. 10 is a graph illustrating vertical vibration of an axis of the omni wheel according to the comparative example. Vertical vibration of the axis of the omni wheel was measured while timing was set to 0 second, and displacement was set to 0 mm when the roller of one of the wheels of the omni wheel was grounded. A material for the roller of the omni wheel according to the comparative example is the same as the general material used for the end portions 5 of the roller 2 according to the embodiment.

First of all, because the roller was elastic, vibration happened due to its own weight when the roller of one of the wheels was grounded. According to FIG. 10, displacement right after the grounding was 1.0 mm. Vibration subsided over time and became stable at around 0.6 mm.

Thereafter, from 0.6 second, the wheels of the omni wheel were driven so as to rotate in the circumferential direction, and vibration of the mobile body was measured while it was traveling. Specifically, the omni wheel was accelerated from 0.6 second through 1.0 second, and the number of rotations was made constant at 1.0 second and on, and then the mobile body traveled at constant speed of 5 km/h. As illustrated in FIG. 10, vibration was generated at 0.6 second, and after 1.0 second when the mobile body started traveling at the constant speed, vibration happened in a displacement range from 0.3 mm to 0.9 mm.

When displacement while the mobile body is traveling is as small as 0.3 mm, in other words, when sinking is small, it means that the rollers of both of the wheels are grounded as illustrated in FIG. 7 and FIG. 9. On the other hand, when the displacement while the mobile body is traveling is as large as 0.9 mm, in other words, when sinking is large, it means that the roller of one of the wheels is grounded as illustrated in FIG. 6 and FIG. 8.

As described above, in the mobile body having the omni wheel according to the comparative examples, when the roller of one of the wheels is grounded, sinking is large because only one roller receives the load. On the other hand, when the rollers of both of the wheels are grounded, sinking is small because the load is dispersed into the two rollers. Vibration is generated because the above happens repeatedly while the mobile body is traveling.

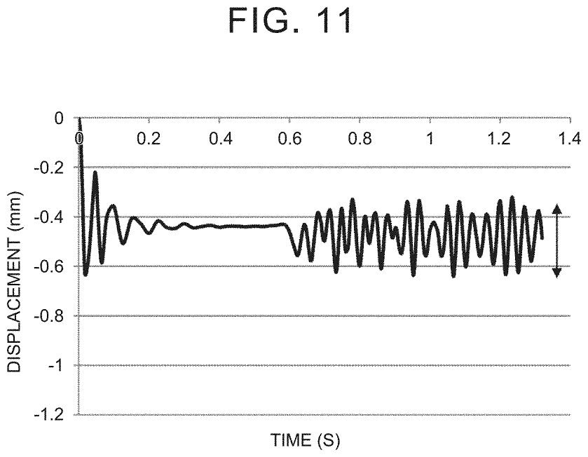

FIG. 11 is a graph illustrating vertical vibration of the axis of the omni wheel 1 according to the first embodiment. Similarly to FIG. 10, vertical vibration of the axis of the omni wheel 1 was measured while timing was set to 0 second, and displacement was set to 0 mm when the roller 2 of one of the wheels 3 of the omni wheel 1 was grounded. In the roller 2 of the omni wheel 1, the high-rigidity material was used for the center portion 4, and the general material was used for the end portions 5.

First of all, because the roller 2 was elastic, vibration happened due to its own weight when the roller 2 of one of the wheels 3 was grounded. At this time, the center portion 4 of the roller 2 is grounded. According to FIG. 11, displacement right after the grounding was 0.6 mm. Vibration subsided over time and stabilized at around 0.4 mm. Since the center portion 4 made of the high-rigidity material is grounded, the sinking due to its own weight was smaller than that illustrated in FIG. 10.

Thereafter, from 0.6 second, the wheels 3 of the omni wheel 1 were driven so as to rotate in the circumferential direction, and vibration of the mobile body was measured while it was traveling. Specifically, the omni wheel 1 was accelerated from 0.6 second through 1.0 second, the number of rotations was made constant at 1.0 second and on, and then the mobile body traveled at constant speed of 5 km/h. As illustrated in FIG. 11, vibration was generated at 0.6 second, and after 1.0 second when the mobile body started traveling at the constant speed, vibration happened in a displacement range from 0.3 mm to 0.6 mm.

When displacement while the mobile body is traveling is as small as 0.3 mm, in other words, when sinking is small, it means that the rollers 2 of both of the wheels 3 are grounded. On the other hand, when the displacement while the mobile body is traveling is as large as 0.6 mm, in other words, when sinking is large, it means the roller 2 of one of the wheels 3 is grounded as illustrated. When FIG. 11 is compared to FIG. 10, it is understood that vibration width of the mobile body 10 according to the first embodiment is almost halved.

As described so far, in the mobile body 10 according to the embodiment, the rigidity of the center portion 4 of the roller 2 is set to be higher than the rigidity of the end portions 5. Thus, it is possible to reduce vibration while the mobile body is traveling.

### Manufacturing Method for Roller

A manufacturing method for the roller 2 is described with reference to FIG. 5. It is possible to manufacture the roller 2 with use of methods such as insert molding and assembly.

In the insert molding, the core 7 having the hole 6 as illustrated in FIG. 5 is set in a resin mold, and resin filling of the high-rigidity material is performed so that center portion 4 is formed. Next, the center portion 4 is set in a resin mold for forming the end portions 5, and then the general material is filled. As a result, the roller 2 according to the embodiment is formed. Alternatively, the roller 2 according to the embodiment may be formed as follows. The core 7 is set in a resin mold where a portion for the tire 8 is formed as a cavity, and the high-rigidity material for forming the center portion 4 and the general material for forming the end portions 5 are filled simultaneously.

For the assembly method, first of all, the high-rigidity material used for the center portion 4 and the general material used for the end portions 5 are formed independently. Next, the high-rigidity material is pressed to the core 7, and an adhesive is used between the core 7 and the high-rigidity material to fix them to each other. Thereafter, the general material is pressed from both sides of the core 7, and an adhesive is used between the general material and the core 7, and between the high-rigidity material and the general material so that they are fixed to one another. With use of the methods described above, it is possible to manufacture the roller 2 according to the embodiment.

The disclosure is not limited to the foregoing embodiment, and changes may be made without departing from the gist of the disclosure.

What is claimed is:

1. A mobile body having an omni wheel in which a pair of wheels is arranged parallel to each other so that phases of the wheels are shifted from each other, each of the wheels having a plurality of rollers in a circumferential direction, wherein rigidity of a center portion of each of the rollers in an axis direction is higher than rigidity of an end portion of the roller in the axis direction.

2. The mobile body according to claim 1, wherein the rigidity of the center portion is 1.5 to 2.5 times as high as rigidity of the end portion.

3. The mobile body according to claim 1, wherein, when a length of each of the rollers in the axis direction is L, a length of the center portion is in a range of L/4 to 3L/4.

4. The mobile body according to claim 1, wherein the center portion and the end portion contain urethane or a rubber material.
